(19) United States
(12) Patent Application Publication
(10) Pub. No.: US 2022/0072990 A1
(43) Pub. Date: Mar. 10, 2022

(54) TRAILER WITH ISOLATED SUITES

(71) Applicant: Kenneth Mitchell, Hendersonville, TN (US)

(72) Inventor: Kenneth Mitchell, Hendersonville, TN (US)

(21) Appl. No.: 17/378,664

(22) Filed: Jul. 17, 2021

Related U.S. Application Data
(60) Provisional application No. 63/075,219, filed on Sep. 7, 2020.

(51) Int. Cl. B60P 3/39

(52) U.S. Cl. CPC B60P 3/39; E04H 1/02

(57) ABSTRACT

Implementations of a trailer with isolated suites are provided. In some implementations, the trailer with isolated suites comprises a road transportable trailer with a plurality of separate isolated living suites or units each having a separate independent heating and air conditioning system and an upper bed or a lower bed alternating on each side of the trailer such that the beds of side-adjacent units are positioned in a vertical bunk bed configuration with the beds separately isolated within in each unit. In some implementations, a method of using the trailer with isolated suites comprises transporting the trailer with isolated suites to a desired location, positioning and setting up the trailer with isolated suites at the location, using the units of the trailer with isolated suites to provide individual living quarters that are completely separated and environmentally isolated from each other for a plurality of users to prevent or minimize the spread of COVID-19 (or other infectious diseases) among the users.

### CROSS REFERENCE TO RELATED APPLICATION

This application claims the benefit of U.S. Patent Application Ser. No. 63/075,219, which was filed on Sep. 7, 2020, and is incorporated herein by reference in its entirety.

### TECHNICAL FIELD

This disclosure relates to implementations of a trailer with isolated suites.

### BACKGROUND

During an emergency response such as a hurricane or tornado response, first responders are needed in an area and are typically housed together in a village type arrangement. These first responders share one or more common areas such as sleeping areas. For example, multiple bunk beds (e.g., as shown in FIG. 1) are housed in a common area.

These stacked bunk beds housed in a common area allow ventilation, including air conditioned air and heated air, to be shared between two or more persons using the bunk beds, since the same sleeping space and same air system are shared.

However, due to COVID-19 (and similar hazards), it is desirable to individually house these first responders to provide safe breathing air.

### BRIEF DESCRIPTION OF THE DRAWINGS

FIG. 1 illustrates an example existing bed.

FIGS. 2-12 illustrate implementations of an example trailer with isolated suites according to the present disclosure.

### DETAILED DESCRIPTION

Implementations of a trailer with isolated suites are provided. In some implementations, the trailer with isolated suites comprises a road transportable trailer with a plurality of separate isolated living suites or units each having a separate independent heating and air conditioning system and an upper bed or a lower bed alternating on each side of the trailer such that the beds of side-adjacent units are positioned in a vertical bunk bed configuration with the beds separately isolated within in each unit.

In some implementations, the trailer with isolated suites is configured to provide protection from spreading COVID-19 (or other infectious diseases) by separating individual personnel from personal and/or physical contact with each other while staying in the units of the trailer with isolated suites.

In some implementations, the trailer with isolated suites is configured to provide a positive air flow within the units of the trailer with isolated suites, such as by an air separation system of each unit.

In some implementations, the trailer with isolated suites is configured such that each unit of the trailer with isolated suites maintains a separate air system and does not share air with the other units.

In some implementations, the trailer with isolated suites is configured to allow for both men and women to stay in separate units of the trailer with isolated suites in the same trailer thereby eliminating the need for separate trailers for each gender.

In some implementations, the trailer with isolated suites is configured to provide separate, environmentally isolated living quarters in a road transportable platform.

In some implementations, the trailer with isolated suites is configured to be towed on a highway or other suitable roadway, such as by a suitable truck or other vehicle.

In some implementations, the trailer with isolated suites is configured to be positioned and setup for use in any suitable location.

In some implementations, the trailer with isolated suites is configured to be transported to any location in the U.S. (or other locales) while meeting the maximum width requirements of 8 feet and 6 inches in width.

In some implementations, by meeting and satisfying state and/or federal Department of Transportation maximum width requirements, the trailer with isolated suites is ready to transport at any time (e.g., ready to roll 24 hours, 7 days a week) for any emergency or need without having to wait required oversized load permits to be issued from each state in which the trailer with isolated suites needs to travel.

In some implementations, a method of using the trailer with isolated suites comprises transporting the trailer with isolated suites to a desired location, positioning and setting up the trailer with isolated suites at the location, using the units of the trailer with isolated suites to provide individual living quarters that are completely separated and environmentally isolated from each other for a plurality of users to prevent or minimize the spread of COVID-19 (or other infectious diseases) among the users.

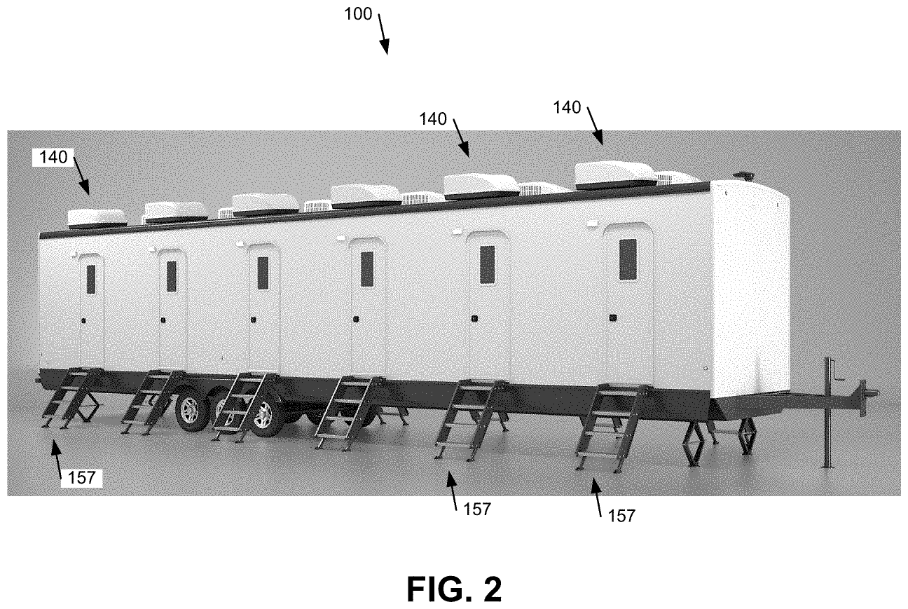

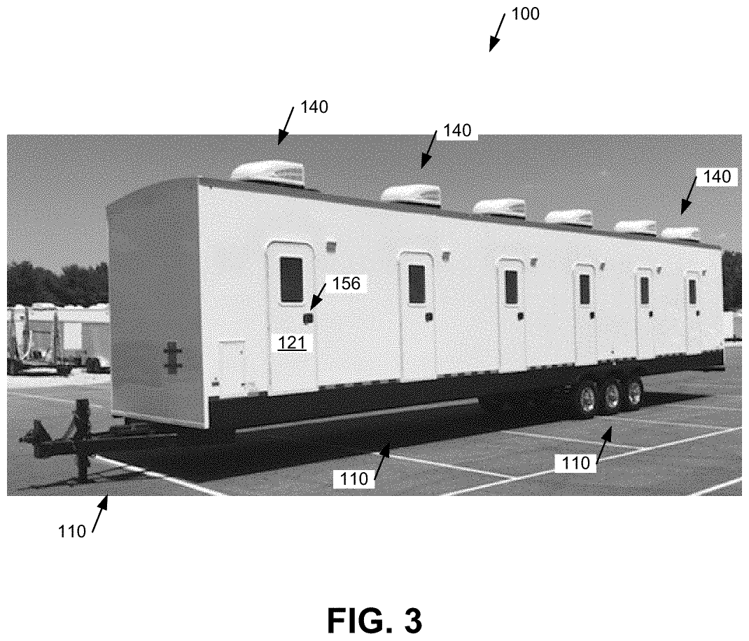

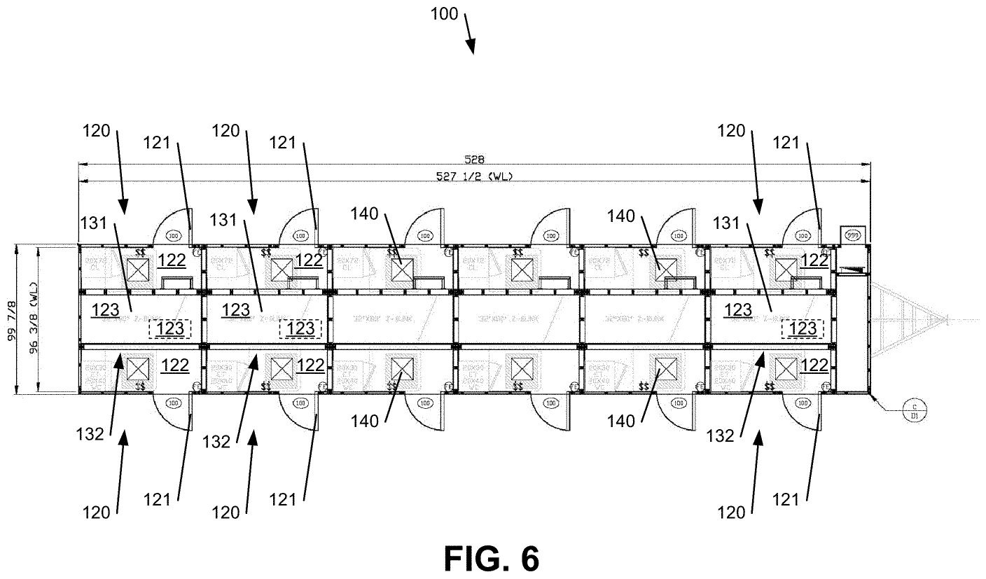

FIGS. 2-12 illustrate implementations of an example trailer with isolated suites 100 according to the present disclosure. As shown in FIG. 3, in some implementations, the trailer with isolated suites 100 comprises a trailer 110. As shown in FIG. 6, in some implementations, the trailer with isolated suites 100 comprises a plurality of suites or units 120.

In some implementations, the trailer with isolated suites 100 may alternately comprise a system and/or method to provide a trailer separated into smaller suites or units so that first responders (or other users) can be housed separately and isolated to prevent the spread of infectious diseases such as COVID-19.

In some implementations, the trailer 110 may be any suitable trailer that can be used for the trailer with isolated suites 100 as described herein. For example, in some implementations, the trailer 110 may be any other suitable trailer that can hold the plurality of units 120 described below and allow the roadway transport of the units 120. In some implementations, the trailer 110 is configured to be towed on a highway or other suitable roadway, such as by a suitable truck or other vehicle.

In some implementations, the trailer 110 may be a flat bed trailer with the units 120 positioned on the bed of the trailer 110. In some implementations, the trailer 110 may be a dry van trailer with units 120 formed in the enclosed compartment of the trailer 110.

In some implementations, the trailer 110 may be any suitable size and shape. For example, in some implementations, the trailer 110 may be generally rectangular prism shaped. In some implementations, the trailer 110 may be suitably sized to hold the plurality of units 120 and allow the use of the trailer with isolated suites 100 as described herein.

In some implementations, the trailer 110 may be configured such that the trailer 110 and the units 120 are separate connected components. In some implementations, the trailer 110 may be configured such that the trailer 110 and the units 120 are an integrated component.

In some implementations, the trailer 110 may be configured such that the trailer 110 and the units 120 can have any other suitable configuration.

As shown in FIG. 6, in some implementations, each unit 120 comprises a separate door 121. As shown in FIG. 6, in some implementations, each unit 120 comprises an upper bed 131 or a lower bed 132. As shown in FIG. 6, in some implementations, each unit 120 comprises a separate air system 140.

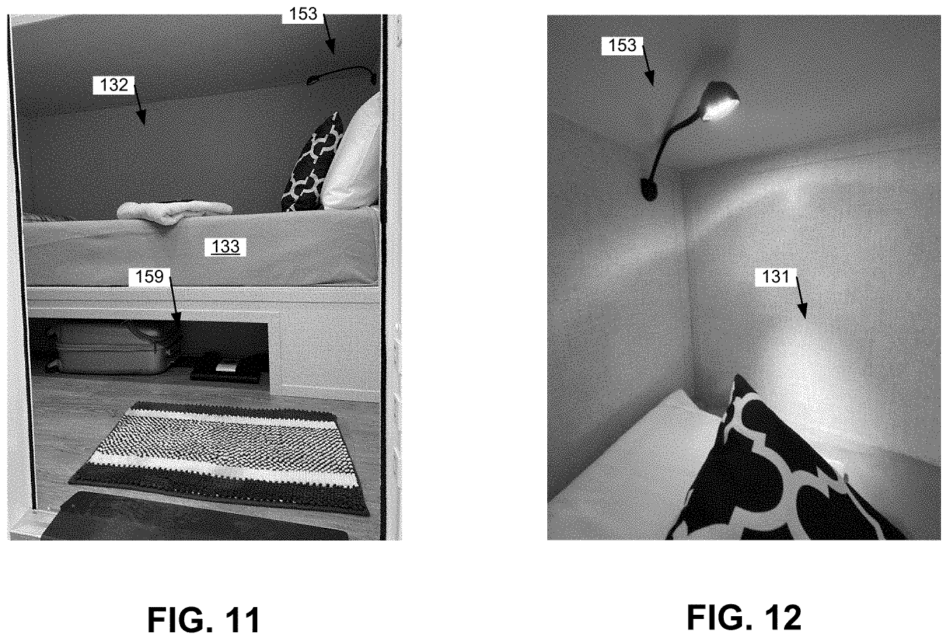

As shown in FIG. 6, in some implementations, each unit 120 may comprise a front area 122 and a bunk area 123. As shown in FIGS. 8-10, in some implementations, each unit 120 may comprise a television 152. As shown in FIGS. 11 and 12, in some implementations, each unit 120 may comprise a reading light 153.

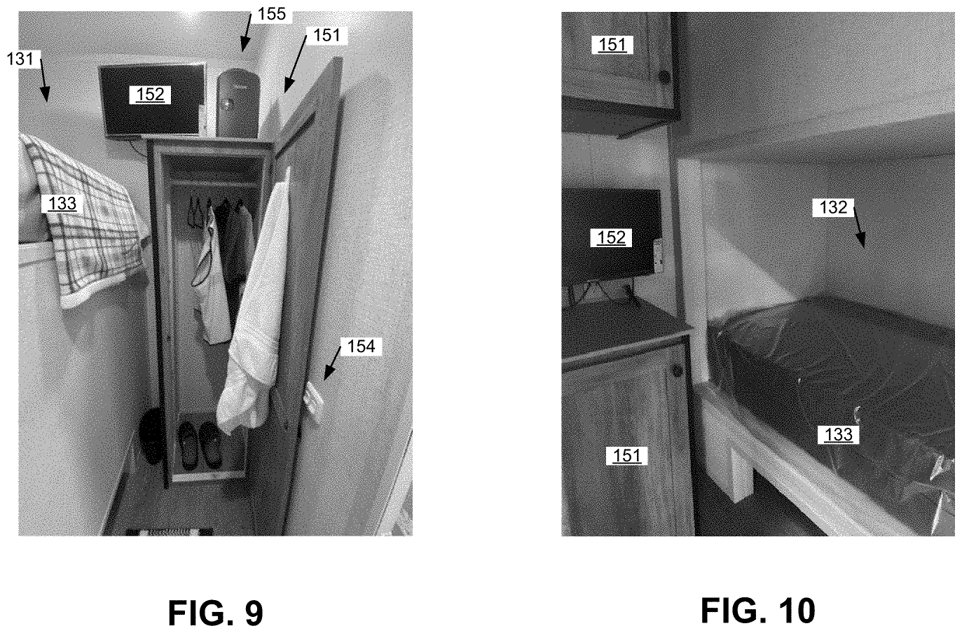

As shown in FIG. 8, in some implementations, each unit 120 may comprise one or more electrical outlets or wall receptacles 154. As shown in FIGS. 8 and 9, in some implementations, each unit 120 may comprise a mini-refrigerator 155. As shown in FIGS. 3 and 5, in some implementations, each unit 120 may comprise an entry lock 156.

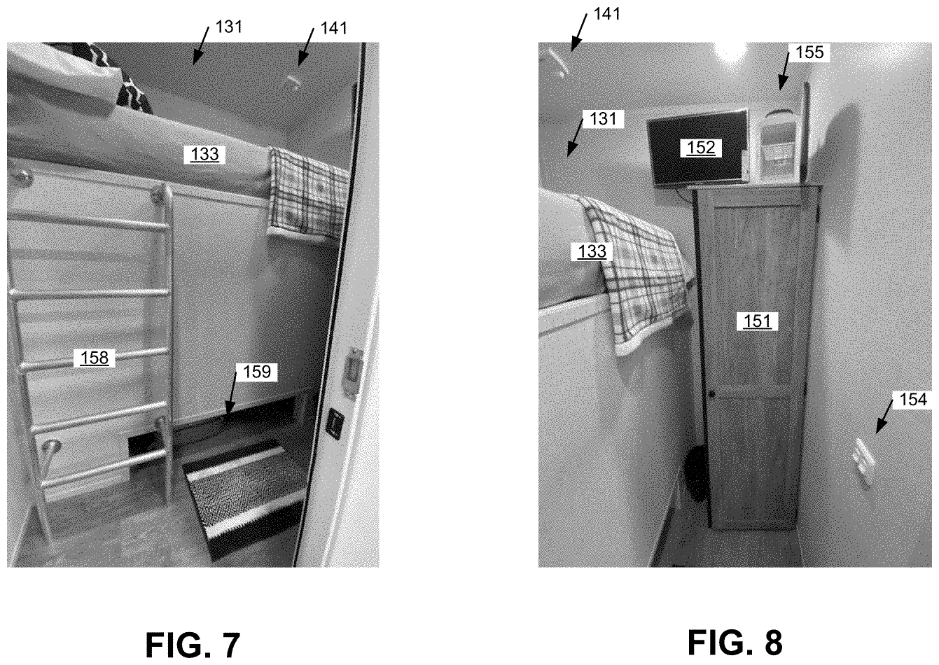

As shown in FIGS. 2, 4, and 5, in some implementations, each unit 120 may comprise an entry stairway 157. As shown in FIG. 8, in some implementations, each unit 120 that houses an upper bed 131 may comprise a ladder 158. As shown in FIGS. 7 and 11, in some implementations, each unit 120 may comprise a storage area 159 positioned under the upper bed 131 or lower bed 132.

As shown in FIG. 6, in some implementations, the trailer with isolated suites 100 is divided into a plurality of units 120. In some implementations, each unit 120 is isolated by walls from other adjacent units 120.

In this way, in some implementations, first responders or other suitable users of the trailer with isolated suites 100 can be socially distanced from each other to help prevent or minimize the spread of infectious diseases.

In some implementations, twelve (12) units 120 are positioned along the length of the trailer 110. In some implementations, each unit 120 is positioned such that there are six (6) units 120 on each side of the trailer 110. For example, in some implementations, there are six units 120 positioned on a first (e.g., left) side of the trailer 110 and six units 120 positioned on a second (e.g., right) side of the trailer 110.

In some implementations, any other suitable number of units 120 may be positioned along the length of the trailer 110. In some implementations, any other suitable number of the units 120 may be positioned on each side of the trailer 110.

In some implementations, the units 120 may be any suitable size and shape. For example, in some implementations, the units 120 may be generally rectangular prism shaped. In some implementations, the units 120 may be suitably sized to house the components and be used as described herein.

In some implementations, each unit 120 may be the same or similar size and shape. In some implementations, one or more of the units 120 may be a different size and/or shape.

As shown in FIG. 6, in some implementations, each unit 120 comprises a separate door 121. In some implementations, the door 121 may be any suitable door. In some implementations, the door 121 may be any suitable size and shape.

In some implementations, the door 121 may comprise a window. In some implementations, the door 121 may comprise any other suitable features, such as the entry lock 156 described below.

In some implementations, the door 121 is configured to provide a separate and/or private entry to the respective unit 120.

As shown in FIG. 6, in some implementations, each unit 120 on a first (e.g., left) side of the trailer with isolated suites 100 comprises an upper bed 131 and each unit 120 on a second (e.g., right) side of the trailer with isolated suites 100 comprises a lower bed 132.

As shown in FIG. 6, in some implementations, each unit 120 may comprise a front area 122 and a bunk area 123. For example, in some implementations, the front area 122 may be adjacent to the door 121 and an exterior side wall of a unit 120. In some implementations, the bunk area 123 may be adjacent to an interior side wall of the unit 120 and/or the lengthwise center area of the trailer 110.

In some implementations, the front area 122 and the bunk area 123 may be in any other suitable positions of the unit 120.

As shown in FIGS. 6, 7 and 11, in some implementations, the bunk area of a unit 120 at least houses an upper bed 131 or a lower bed 132. As shown in FIGS. 8-10, in some implementations, the front area of the unit 120 may at least house a cabinet and/or closet area 151 and a television 152.

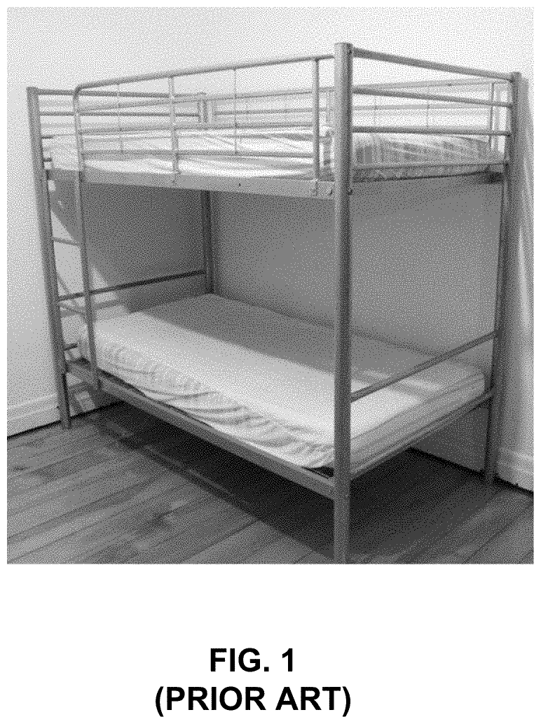

As shown in FIG. 6, in some implementations, the bunk area 123 of adjacent units 120 on each side (e.g., left side and right side) of the trailer with isolated suites 100 overlap each other (e.g., in a stacked configuration) similarly to bunk beds such as shown in FIG. 1. However, in some implementations, the upper bed 131 and lower bed 132 of the adjacent units 120 on each side are housed separate and isolated in the respective units 120.

In some implementations, the beds 131, 132 are positioned at varying or rotating heights such that the upper bed 131 of a unit 120 on the first side of the trailer 110 is positioned above the lower bed 132 of the separate adjacent unit 120 on the second side of the trailer 110.

FIGS. 7-11 further illustrate an example of side-adjacent units 120 of the trailer with isolated suites 100. For example, FIGS. 7-9 illustrate a front area and bunk area of a first unit 120 on one side (e.g., the left side) of the trailer with isolated suites 100. Similarly, FIGS. 10-11 illustrate a front area and bunk area of a second unit 120 on the other side (e.g., the right side) of the trailer with isolated suites 100 and side-adjacent to the first unit 120.

In some implementations, the upper bed 131 of the first unit 120 is above the lower bed 132 of the second unit 120. As shown in FIG. 7, in some implementations, the area behind the wall below the upper bed 131 of the first unit 120 comprises the lower bed 132 of the second unit 120. As shown in FIG. 10, in some implementations, the area behind the wall above the lower bed 132 of the second unit 120 comprises the upper bed 131 of the first unit 120.

In this way, as shown in FIGS. 6, 7, and 10, in some implementations, the beds 131, 132 are positioned in a bunk bed configuration (e.g., vertically stacked) but are housed separate and isolated in the respective units 120. Furthermore, in this way, as shown in FIG. 6, in some implementations, the beds 131, 132 are positioned in a bunk bed configuration that allows the trailer with isolated suites 100 be compactly divided into a plurality of separate units 120 with the beds 131, 132 co-positioned along the center length of the trailer with isolated suites 100.

In some implementations, the beds 131, 132 may be positioned in any other suitable configuration such that the beds 131, 132 are positioned in a bunk bed configuration housed respectively in each adjacent unit 120.

In some implementations, the beds 131, 132 may be any suitable size and shape. For example, in some implementations, the beds 131, 132 may be rectangular prism shaped similar to other beds or bunk beds. In some implementations, the beds 131, 132 are sized and shaped to allow a suitable user, such as an adult, to use the beds 131, 132.

In some implementations, the beds 131, 132 may extend lengthwise parallel to the length of the trailer 110. In some implementations, the beds 131, 132 may extend in any other suitable way.

As shown in FIGS. 7 and 10, in some implementations, each bed 131, 132 may comprise a ten (10) inch hospital grade foam mattress 133. In some implementations, the mattress 133 may be any other suitable size, such as greater than or less than 10 inches.

In some implementations, the mattress 133 may be any other suitable grade of mattress 133. In some implementations, the mattress 133 may be of any other suitable material.

In some implementations, the mattress 133 may further comprise a rubber coating that allows the mattress 133 to be sanitized after each use. In some implementations, the mattress 133 may further comprise any other suitable features.

As shown in FIG. 6, in some implementations, each unit 120 of the trailer with isolated suites 100 comprises a separate air system 140. In some implementations, the air system 140 may be or comprise an air separation system that creates a positive air flow within each unit 120.

As shown in FIGS. 2 and 3, in some implementations, the air system 140 of each unit 120 may be mounted on top of the unit 120. For example, in some implementations, an air system 140 for each unit 120 is mounted on the roof of the trailer with isolated suites 100 over the respective unit 120.

In some implementations, the air system 140 may comprise an air conditioning (A/C) unit and/or a heat pump.

In some implementations, the air system 140 may comprise any suitable ventilation system. For example, in some implementations, the air system 140 may comprise a heating, ventilation, and air conditioning (HVAC) system.

In some implementations, each air system (and/or air separation system) 140 may comprise a 13,500 British Thermal Units (BTUs) heat and cooling system that is configured to heat and cool a respective unit 120 of the trailer 110.

In some implementations, the air systems 140 are configured to distribute and/or recirculate conditioned (e.g., cooled, heated, and/or filtered) air through a respective unit 120.

In some implementations, the air systems 140 are configured such that each unit 120 does not share air with other units 120.

In some implementations, the air systems 140 are configured to prevent the spread of coronavirus COVID-19 (or other infectious diseases) between units 120 of the trailer with isolated suites 100 by being separate and isolated for each respective unit 120.

In some implementations, each air system (and/or air separation system) 140 is configured to create a positive air flow within a respective unit 120. In some implementations, the air system 140 is so configured by being oversized in capacity for the unit 120 such that the air system 140 takes out conditioned air from the unit 120 faster than it is used in the unit 120.

In some implementations, the air system 140 is configured to provide a complete separation of the air in the respective unit 120 such that a cross contamination of the air (such as by COVID-19 or other infectious diseases) is prevented.

As shown in FIGS. 7 and 8, in some implementations, user controls 141 for the air system 140 of each unit 120 are located separately inside each respective unit 120. For example, in some implementations, the user controls 141 may be mounted along the ceiling area above each respective bed 131, 132 of the unit 120.

As shown in FIGS. 8-10, in some implementations, each unit 120 of the trailer with isolated suites 100 may comprise a television (TV) 152 mounted in the unit 120. In some implementations, the television 152 may be any suitable television that can be used in the trailer with isolated suites 100 as described herein.

In some implementations, the television 152 may be a twenty-four inch (24″) television. In some implementations, the television 152 may be any other suitable size.

In some implementations, the television 152 may be positioned on a wall of a unit 120. For example, in some implementations, the television 152 may be positioned on a side wall of the unit 120.

In some implementations, the television 152 may be positioned on any other suitable location of the unit 120. In some implementations, the television 152 may be positioned at any other suitable location of the unit 120.

As shown in FIGS. 11 and 12, in some implementations, each unit 120 of the trailer with isolated suites 100 may comprise a reading light 153. In some implementations, the reading light 153 may be any suitable light that can be used in the trailer with isolated suites 100 as described herein.

In some implementations, the reading light 153 may be positioned on a wall of a unit 120. For example, in some implementations, the reading light 153 may be positioned on an upper wall or side wall of the unit 120. In some implementations, the reading light 153 may be positioned on any other suitable location of the unit 120.

In some implementations, the reading light 153 may be positioned near the respective bed 131, 132 of the unit 120. For example, in some implementations, the reading light 153 may be positioned over the head or pillow area of the respective bed 131, 132 of the unit 120. In some implementations, the reading light 153 may be positioned at any other suitable location of the unit 120.

As shown in FIG. 8, in some implementations, each unit 120 of the trailer with isolated suites 100 may comprise one or more electrical outlets or wall receptacles 154. In some implementations, the wall receptacle 154 may be any suitable wall receptacle that can be used in the trailer with isolated suites 100 as described herein.

In some implementations, the wall receptacle 154 may be positioned on a wall of a unit 120. For example, in some implementations, the wall receptacle 154 may be positioned on a side wall of the unit 120. In some implementations, the wall receptacle 154 may be positioned on any other suitable location of the unit 120.

In some implementations, the wall receptacle 154 may be positioned near the respective bed 131, 132 of the unit 120. For example, in some implementations, the wall receptacle 154 may be positioned near the head and/or foot area of the respective bed 131, 132 of the unit 120. In some implementations, the wall receptacle 154 may be positioned at any other suitable location of the unit 120.

In some implementations, the wall receptacle 154 may be configured to use for phone recharging. In some implementations, the wall receptacle 154 may be configured to use for a C-Pap machine. In some implementations, the wall receptacle 154 may be configured for any other suitable use.

As shown in FIGS. 8 and 9, in some implementations, each unit 120 of the trailer with isolated suites 100 may comprise a refrigerator 155. In some implementations, the refrigerator 155 may be any suitable refrigerator that can be used in the trailer with isolated suites 100 as described herein.

In some implementations, the refrigerator 155 may be a mini-refrigerator. In some implementations, the refrigerator 155 may be any other suitable size refrigerator.

In some implementations, the refrigerator 155 may be positioned in any suitable location of a unit 120. For example, in some implementations, the refrigerator 155 may be positioned on a cabinet 152 or floor of the unit 120.

In some implementations, the refrigerator 155 may be configured to use for water or beverage cooling. For example, in some implementations, the refrigerator 155 may be to use for cooling water bottles or soda drinks.

In some implementations, the refrigerator 155 may be configured for any other suitable use.

As shown in FIGS. 3 and 5, in some implementations, each unit 120 of the trailer with isolated suites 100 may comprise an entry lock 156. In some implementations, the entry lock 156 is attached to and configured to lock the door 121 of the unit 120.

In some implementations, the entry lock 156 may comprise a keyless-coded entry lock with a deadbolt. In some implementations, the entry lock 156 may comprise any other suitable type of lock.

In some implementations, the entry lock 156 any suitable parts of the entry lock 156 may be positioned on the inner side of the door 120, such as to insure security from tampering with the lock 156.

In some implementations, the entry lock 156 is configured to provide complete security of a unit 120, such as to secure the user, personal items, etc. in the unit 120 from undesired access.

As shown in FIGS. 2, 4, and 5, in some implementations, each unit 120 of the trailer with isolated suites 100 may comprise an entry stairway 157. In some implementations, the stairway 157 may be a retractable or foldable step-ladder style stairway. In some implementations, the stairway 157 may be any other suitable type of stairway.

In some implementations, the stairway 157 may be attached to the trailer with isolated suites 100 at the doorway of a unit 120 below and adjacent to the door 121. In some implementations, the stairway 157 may be attached to the trailer with isolated suites 100 in any other suitable configuration.

In some implementations, the stairway 157 is configured to allow a user to step up from the ground or other surface to enter a unit 120. In some implementations, the stairway 157 is configured to allow a user to step down to the ground or other surface to exit the unit 120.

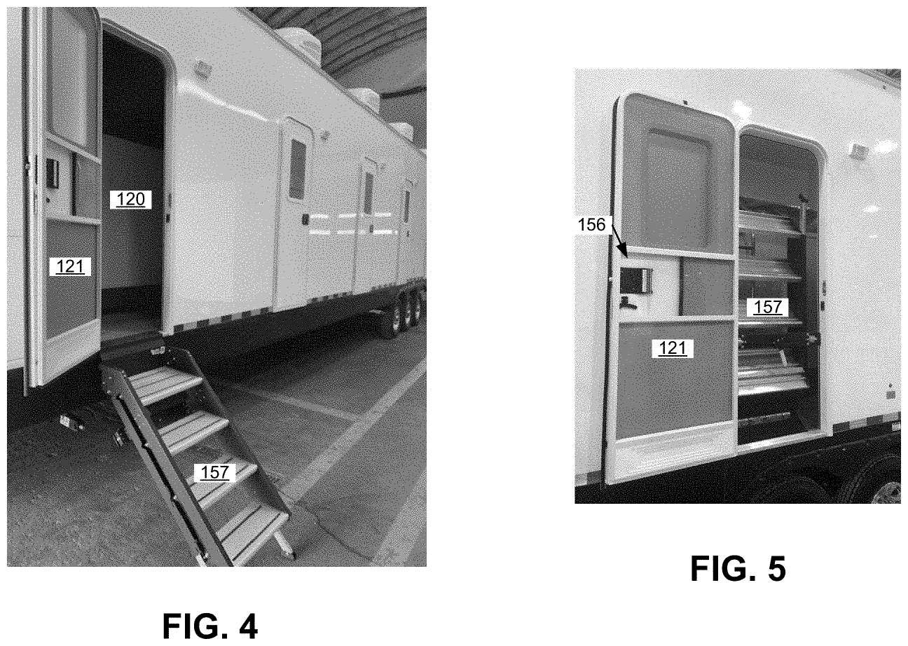

As shown in FIGS. 4 and 5, in some implementations, the stairway 157 may be retractable or otherwise moveable such that the stairway 157 can be moved from a position for use to a position for storage, such as in the unit 120.

In some implementations, the stairway 157 may be configured to allow any other suitable use.

As shown in FIG. 8, in some implementations, each unit 120 of the trailer with isolated suites 100 that houses an upper bed 131 may comprise a ladder 158. In some implementations, the ladder 158 may be any suitable ladder, such as similar to a ladder of a bunk bed such as shown in FIG. 1.

In some implementations, the ladder 158 is attached to the upper bed 131 and/or other area of the unit 120. In some implementations, the ladder 158 is attached such that the ladder 158 can be used to climb up to or down from the upper bed 131 of a unit 120.

In some implementations, the ladder 158 is configured to allow a user to climb up to or down from the upper bed 131 of a unit 120.

As shown in FIGS. 7 and 11, in some implementations, each unit 120 of the trailer with isolated suites 100 may comprise a storage area 159 positioned under the upper bed 131 or lower bed 132. In some implementations, the storage area 159 may be adjacent to the floor of the unit 120. In some implementations, the storage area 159 may be in any other suitable position.

In some implementations, the storage area 159 may be any other suitable size and shape. For example, in some implementations, the storage area 159 may be sized and shaped to allow the storage of a suitcase, other baggage, and/or any other suitable items. In some implementations, the storage area 159 may be generally rectangular shaped.

In some implementations, each unit 120 of the trailer with isolated suites 100 is configured to maintain a separate air system and not share air with other units 120.

In some implementations, each unit 120 of the trailer with isolated suites 100 is configured to create a positive air flow within the unit 120, such as by the air system and/or air separation system 140.

In some implementations, each unit 120 of the trailer with isolated suites 100 is configured to provide available storage 159 under the respective bed 131, 132 of the unit 120 and in one or more wall cabinets 151 of the unit 120.

In some implementations, the units 120 are configured to provide separate, environmentally isolated living quarters, such as described herein.

In some implementations, the units 120 may be configured to be positioned on another suitable platform other than the trailer 110. In some implementations, the units 120 may be configured to be positioned as a separate structure without the trailer 110 or other platform.

In some implementations, the units 120 may be configured to be positioned in any other suitable way.

In some implementations, the trailer with isolated suites 100 may be any suitable size and shape. For example, similar to the above described trailer 110 and plurality of units 120, in some implementations, the trailer 110 may be generally rectangular prism shaped.

In some implementations, the trailer with isolated suites 100 is configured to provide protection from spreading COVID-19 (or other infectious diseases) by separating individual personnel from personal and/or physical contact with each other while staying in the units 120 of the trailer with isolated suites 100.

In some implementations, the trailer with isolated suites 100 is configured to provide a positive air flow within the units 120 of the trailer with isolated suites 100, such as by an air separation system of each unit 120.

In some implementations, the trailer with isolated suites 100 is configured such that each unit 120 of the trailer with isolated suites 100 maintains a separate air system and does not share air with the other units 120.

In some implementations, the trailer with isolated suites 100 is configured to allow for both men and women to stay in separate units 120 of the trailer with isolated suites 100 in the same trailer 110 thereby eliminating the need for separate trailers 110 for each gender.

In some implementations, the trailer with isolated suites 100 is configured to provide separate, environmentally isolated living quarters in a road transportable platform.

In some implementations, the trailer with isolated suites 100 is configured to be towed on a highway or other suitable roadway, such as by a suitable truck or other vehicle.

In some implementations, the trailer with isolated suites 100 is configured to be positioned and setup for use in any suitable location.

In some implementations, the trailer with isolated suites 100 is configured to be transported to any location in the U.S. (or other locales) while meeting the maximum width requirements of 8 feet and 6 inches in width.

In some implementations, by meeting and satisfying state and/or federal Department of Transportation maximum width requirements, the trailer with isolated suites 100 is ready to transport at any time (e.g., ready to roll 24 hours, 7 days a week) for any emergency or need without having to wait required oversized load permits to be issued from each state in which the trailer with isolated suites 100 needs to travel.

In some implementations, the trailer with isolated suites 100 comprises any suitable dimensions. For example, in some implementations, trailer with isolated suites 100 may be approximately forty-six (46) feet long (e.g., from front to back), eight (8) feet wide (e.g., from side to side), and (8) feet tall (e.g., from bottom/floor to top/roof).

In some implementations, the trailer with isolated suites 100 may be greater than or less than 46 feet long. In some implementations, the trailer with isolated suites 100 may be greater than or less than 8 feet wide. In some implementations, the trailer with isolated suites 100 may be greater than or less than 8 feet tall.

FIG. 6 illustrates other example dimensions of the trailer with isolated suites 100.

In some implementations, the trailer with isolated suites 100 is composed of any suitable materials.

In some implementations, the trailer with isolated suites 100 can have any suitable appearance, such as the example appearances shown in the figures.

In some implementations, an example method of using the trailer with isolated suites 100, with respect to the above-described figures, comprises transporting the trailer with isolated suites 100 on a roadway to a desired location such as a location where first responders need to be deployed for an extended time period. In some implementations, the trailer with isolated suites 100 may be transported by being towed by a truck or other suitable vehicle connected to the trailer 110.

In some implementations, the method comprises positioning and setting up the trailer with isolated suites 100 for use at the desired location. In some implementations, the trailer with isolated suites 100 may be disconnected from the tow vehicle and suitably stabilized, such as with jack stands and/or other suitable devices as shown in FIG. 2.

In some implementations, the method comprises using the units 120 to provide individual living, sleeping, etc. quarters for a plurality of users such that the users are completely separated and environmentally isolated from each other such that the spread of COVID-19 (or other infectious diseases) to and/or between the users is prevented or minimized. In some implementations, the separate air systems 140 of the units can be used to heat or cool the units 120.

In some implementations, the beds 131, 132 can be used to allow the users to sleep or otherwise use the beds 131, 132 in the separate isolated bunk bed configuration of the trailer with isolated suites 100. In some implementations, any other suitable features of the units 120, such as described above, can be used while avoiding the spread of COVID-19 (or other infectious diseases) to and/or between the users of the trailer with isolated suites 100.

In some implementations, the method may further comprise closing down and removing the trailer with isolated suites 100 from the desired location after use of the trailer with isolated suites 100 is finished. In some implementations, the trailer with isolated suites 100 is transported from the location the same or similar to as described above for transporting the trailer with isolated suites 100 to the location.

The figures, including photographs and drawings, comprised herewith may represent one or more implementations of the trailer with isolated suites.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A multi-unit living structure comprising:
a plurality of pairs of adjacent living quarters wherein each pair of adjacent living quarters comprises a first living quarter and a second living quarter, wherein:
each living quarter comprises an enclosed interior space defined by walls that is separate from the enclosed interior space of the other living quarters; and
each living quarter comprises in the enclosed interior space a bunk area having a bed positioned therein and a front area adjacent to the bunk area, wherein for each pair of adjacent living quarters:
the first living quarter comprises a first bed positioned at a first height in the bunk area of the first living quarter;
the second living quarter comprises a second bed positioned at a second height in the bunk area of the second living quarter, wherein the first height is greater than the second height; and
the bunk area of the first living quarter and the bunk are of the second living quarter are positioned adjacent to each other on opposite sides of a wall such that the bunk areas overlap each other such that the first bed in the bunk area of the enclosed interior space of the first living quarter and the second bed in the bunk area of the enclosed interior space of the second living quarter are aligned vertically in a bunk bed configuration separately enclosed in the respective enclosed interior space.

2. The multi-unit living structure of claim 1 wherein each living quarter comprises a separate ventilation system configured such that each living quarter does not share air in the respective enclosed interior space with the other living quarters.

3. The multi-unit living structure of claim 2 wherein the ventilation system is configured to create a positive air flow within the interior space of the respective living quarter such that air is circulated out of the living quarter faster than the air is used in the living quarter.

4. The multi-unit living structure of claim 1 further comprising a road transportable trailer, wherein:
the plurality of living quarters are positioned on the trailer; and
a first side of the trailer is adjacent to the first side of the structure and a second side of the trailer is adjacent to the second side of the structure.

5. The multi-unit living structure of claim 4 wherein the trailer comprises a flat bed trailer and the living quarters are positioned on the bed of the trailer.

6. The multi-unit living structure of claim 4 wherein the trailer comprises a dry van trailer having an enclosed compartment and the living quarters are formed in the compartment of the trailer.

7. The multi-unit living structure of claim 2 further comprising a user control for the ventilation system of each living quarter positioned in the bunk area adjacent to the bed of the living quarter.

8. The multi-unit living structure of claim 1 further comprising a storage area positioned below the bed in the bunk area of each of the living quarters.

9. The multi-unit living structure of claim 1 further comprising a storage cabinet positioned in the front area of each of the living quarters.

10. The multi-unit living structure of claim 1 further comprising a television positioned in the front area of each of the living quarters.

11. The multi-unit living structure of claim 1 further comprising a reading light positioned in the bunk area adjacent to the bed of each of the living quarters.

12. The multi-unit living structure of claim 1 further comprising an electrical outlet positioned in the front area of each of the living quarters.

13. The multi-unit living structure of claim 1 further comprising a mini-refrigerator positioned in the front area of each of the living quarters.

14. The multi-unit living structure of claim 1 wherein:
the structure is about 46 feet long, 8 feet and 6 inches wide, and 8 feet and 6 inches tall;
there are six living quarters along the first and second sides of the trailer; and
each living quarter is about 7 feet and 8 inches long, 5 feet and 7 inches wide, and 8 feet and 6 inches tall.

15. The multi-unit living structure of claim 1 wherein:
the structure is about 40 feet long, 8 feet wide, and 7 feet tall;
there are six living quarters along the first and second sides of the trailer; and
each living quarter is about 6 feet and 8 inches long, 5 feet wide, and 7 feet tall.

16. A method of using the multi-unit living structure of claim 1 comprising:
a first user occupying the bed in the first living quarter and a second user occupying the bed in the second living quarter such that the first and second users are physically separated and laying in a bunk bed configuration in separate enclosed interior spaces.

17. A multi-unit living structure comprising:
a plurality of pairs of adjacent living quarters wherein each pair of adjacent living quarters comprises a first living quarter and a second living quarter, wherein:
each living quarter comprises an enclosed interior space defined by walls that is separate from the enclosed interior space of the other living quarters;
each living quarter comprises a separate ventilation system configured such that each living quarter does not share air in the respective enclosed interior space with the other living quarters; and
each living quarter comprises in the enclosed interior space a bunk area having a bed positioned therein and a front area adjacent to the bunk area, wherein for each pair of adjacent living quarters:
the first living quarter comprises a first bed positioned at a first height in the bunk area of the first living quarter;
the second living quarter comprises a second bed positioned at a second height in the bunk area of the second living quarter, wherein the first height is greater than the second height; and
the bunk area of the first living quarter and the bunk are of the second living quarter are positioned adjacent to each other on opposite sides of a wall such that the bunk areas overlap each other such that the first bed in the bunk area of the enclosed interior space of the first living quarter and the second bed in the bunk area of the enclosed interior space of the second living quarter are aligned vertically in a bunk bed configuration separately enclosed in the respective enclosed interior space.

18. A method of using the multi-unit living structure of claim 17 comprising:
a first user occupying the bed and using the ventilation system in the first living quarter and a second user occupying the bed and using the ventilation system in the second living quarter such that the first and second users are physically separated and laying in a bunk bed configuration in separate enclosed interior spaces and do not share air in the enclosed interior spaces.

19. A multi-unit living structure comprising:
a road transportable trailer; and
a plurality of pairs of adjacent living quarters wherein each pair of adjacent living quarters comprises a first living quarter and a second living quarter, wherein:
each living quarter comprises an enclosed interior space defined by walls that is separate from the enclosed interior space of the other living quarters;
each living quarter comprises a separate ventilation system configured such that each living quarter does not share air in the respective enclosed interior space with the other living quarters;
each living quarter comprises in the enclosed interior space a bunk area having a bed positioned therein and a front area adjacent to the bunk area, wherein for each pair of adjacent living quarters:
the first living quarter comprises a first bed positioned at a first height in the bunk area of the first living quarter;
the second living quarter comprises a second bed positioned at a second height in the bunk area of the second living quarter, wherein the first height is greater than the second height; and
the bunk area of the first living quarter and the bunk are of the second living quarter are positioned adjacent to each other on opposite sides of a wall such that the bunk areas overlap each other such that the first bed in the bunk area of the enclosed interior space of the first living quarter and the second bed in the bunk area of the enclosed interior space of the second living quarter are aligned vertically in a bunk bed configuration separately enclosed in the respective enclosed interior space;
each living quarter comprises in the bunk area of the living quarter:
a storage area positioned below the bed of the living quarter;
a user control for the ventilation system of the living quarter positioned adjacent to the bed of the living quarter; and
a reading light positioned adjacent to the bed of the living quarter; ach living quarter comprises positioned in the front area of the living quarter:
a storage cabinet;
a television;
an electrical outlet; and
a mini-refrigerator; and
each living quarter comprises:
a keyless-coded entry lock with a deadbolt on a door of the living quarter; and
a retractable stairway positioned at a doorway of the living quarter.

20. A method of using the multi-unit living structure of claim 19 comprising:
transporting the structure to a location by towing the trailer; and
a first user occupying the bed and using the ventilation system in the first living quarter and a second user occupying the bed and using the ventilation system in the second living quarter such that the first and second users are physically separated and laying in a bunk bed configuration in separate enclosed interior spaces and do not share air in the enclosed interior spaces.
